(19) United States
(12) Patent Application Publication
(10) Pub. No.: US 2021/0093017 A1
(43) Pub. Date: Apr. 1, 2021

(54) Modular Vape Device

(71) Applicant: Yigal Cohen Harel, Ratingen (DE)

(72) Inventor: Yigal Cohen Harel, Ratingen (DE)

(21) Appl. No.: 16/423,111

(22) Filed: Sep. 29, 2019

(51) Int. Cl. A24F 47/00; H05B 3/42

(52) U.S. Cl. CPC A24F 47/008; H05B 3/42

(57) ABSTRACT

A vape device of the present invention includes a first fluid channel, a second fluid channel, a first fluid valve, a second fluid valve, and a heat exchanger that exchanges heat between the first fluid channel and the second fluid channel; and wherein the first fluid valve and the second fluid valve are in series and operate synchronously to supply an e-liquid, by way of the first fluid channel, to the heat exchanger.

### FIELD OF THE INVENTION

The present invention generally relates to devices and methods for vaporizing an e-liquid and more specifically to devices and methods for supplying an e-liquid to a vaporization device.

### SUMMARY

A vape device of the present invention includes a first fluid channel, a second fluid channel, a first fluid valve, a second fluid vale, and a heat exchanger that exchanges heat between the first fluid channel and the second fluid channel; and wherein the first fluid valve and the second fluid valve are in series and operate synchronously to supply an e-liquid, by way of the first fluid channel, to the heat exchanger.

The vape device may further comprise a first e-liquid storage area and a second e-liquid storage area. The first fluid channel may fluidly connect the first e-liquid storage area to the second e-liquid storage area. The first fluid valve and the second fluid valve may be located between the first e-liquid storage area and the second e-liquid storage area; and wherein the first e-liquid storage area may have a liquid volume capacity between 0.1 ml and 100 ml and the second liquid storage area may have a liquid volume capacity between 0.001 ml and 2 ml. The first fluid valve and the second fluid valve may provide a sealed disconnection between the first e-liquid storage area and the second e-liquid storage area. The sealed disconnection may synchronously seal the first e-liquid storage area and the second e-liquid storage area, preventing leakage, when the first e-liquid storage area is modularly separated from the second e-liquid storage area. The first fluid valve and the second fluid valve may operate synchronously by the first fluid valve mechanically interacting with the second fluid valve. The mechanically interacting may comprise a first valve stem of the first fluid valve pushing against a second valve stem of the second fluid valve. The first valve stem and the second valve stem may each be biased in a normally closed position when the first e-liquid storage area is modularly separated from the second e-liquid storage area. The e-liquid may be vaporized by heat transfer of the heat exchanger and the vaporized e-liquid may be supplied through the second fluid channel to a user of the vape device.

A method of providing an e-liquid to a heat exchanger of a vape device includes attaching a first e-liquid storage area containing the e-liquid and a first fluid valve to the vape device, the vape device containing a second fluid valve attached to a second e-liquid storage area; and wherein the first fluid valve and the second fluid valve synchronously and fluidly interact to provide the e-liquid to the heat exchanger of the vape device as a result of the attaching.

The first fluid valve and the second fluid valve may synchronously open as the first e-liquid storage area and the second e-liquid storage area are joined together. The first fluid valve and the second fluid valve may synchronously close as the first e-liquid storage area and the second e-liquid storage area are separated. The first fluid valve and the second fluid valve may be located between the first e-liquid storage area and the second e-liquid storage area. The first e-liquid storage area may supply the e-liquid to the second e-liquid storage area by gravity. The first e-liquid storage area may supply the e-liquid to the second e-liquid storage area by vacuum pressure. The first fluid valve and the second fluid valve may operate synchronously as a result of the first fluid valve mechanically interacting with the second fluid valve. The mechanically interacting may comprise a first valve stem of the first fluid valve pushing against a second valve stem of the second fluid valve. The first valve stem and the second valve stem may be each biased in a normally closed position when the first e-liquid storage area is modularly separated from the second e-liquid storage area. The e-liquid may be vaporized by heat transfer through the heat exchanger.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a cross-sectional view of a disconnected vape device in accordance with an embodiment of the invention;

FIG. 2 shows a cross-sectional view of a connected vape device in accordance with an embodiment of the invention;

FIG. 3 shows an exploded view of a tank assembly in accordance with an embodiment of the invention;

FIG. 4 shows an exploded view of a heat exchange assembly in accordance with an embodiment of the invention;

FIG. 5 shows an exploded perspective view of a vape device in accordance with an embodiment of the invention;

FIG. 6 shows a perspective view of an electric lighter and vape devices in accordance with an embodiment of the invention;

FIG. 7 shows a perspective view of an electric lighter and vape device in accordance with an embodiment of the invention;

FIG. 8 shows a perspective view of a vape device in accordance with an embodiment of the invention;

FIG. 9 shows a perspective view of a vape device in accordance with an embodiment of the invention; and

FIG. 10 shows a perspective view of a vape cigar in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

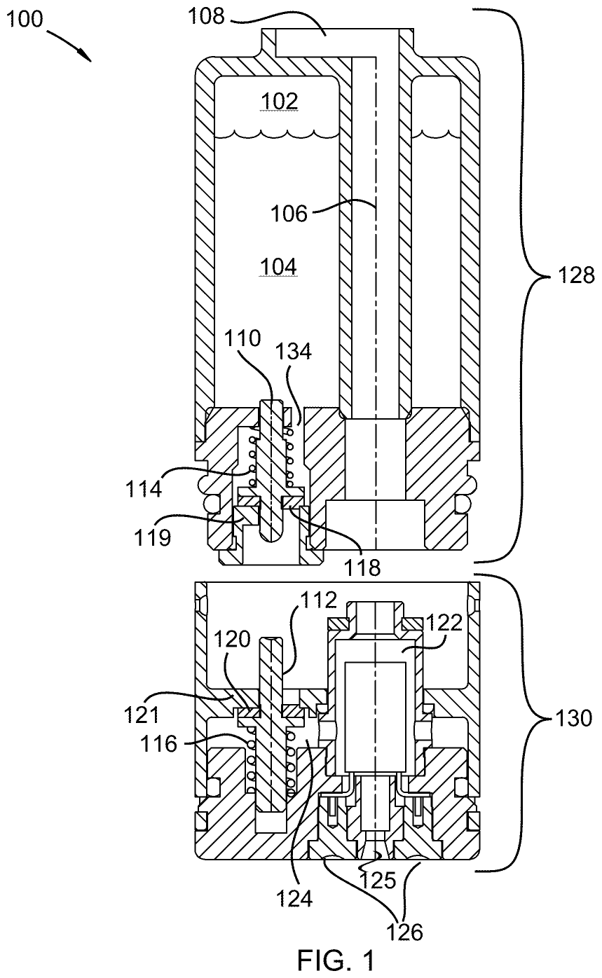

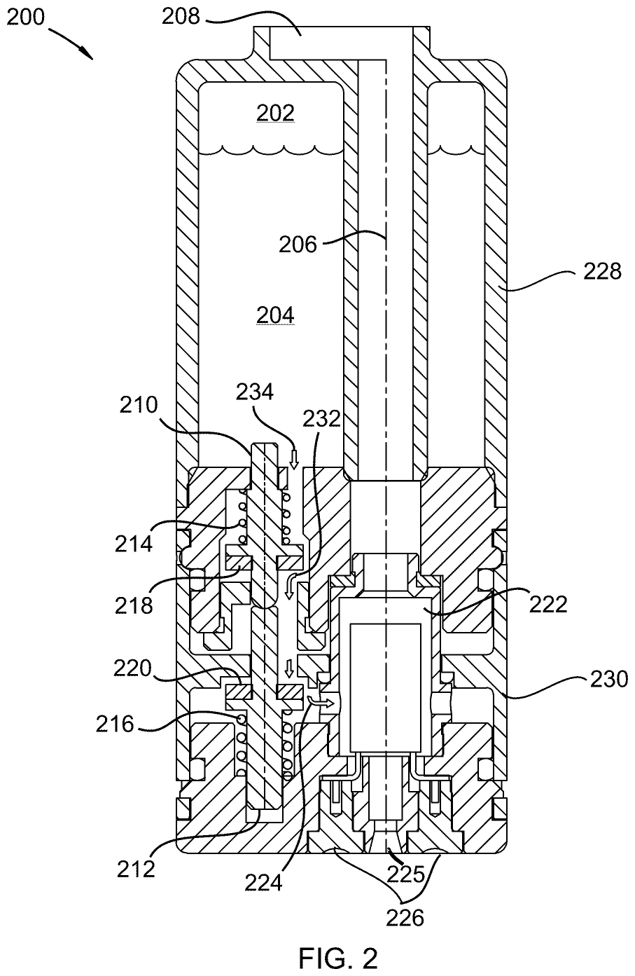

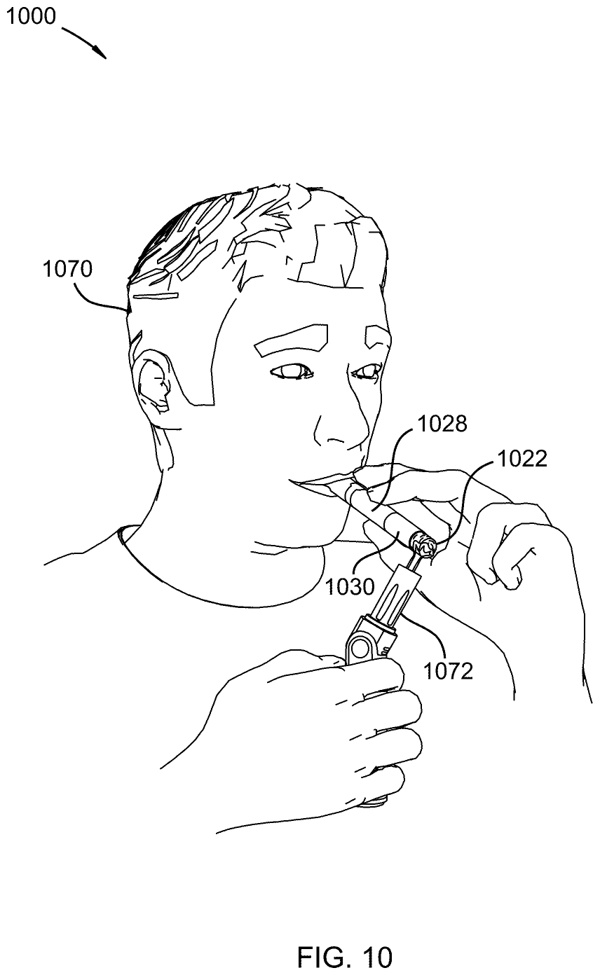

FIG. 1 shows a cross-sectional view of a disconnected vape device 100 in accordance with an embodiment of the invention. Vape device 100 includes tank assembly 128 and heat exchange assembly 130. Tank assembly 128 includes a first e-liquid storage area 102, an e-liquid 104, an outlet port 108, a first fluid valve 110, a portion of a first fluid channel 134, and a portion of a second fluid channel 106. First e-liquid storage area 102 includes e-liquid 104 and a first fluid channel which connects e-liquid 104 with a second e-liquid storage area 124 in the heat exchange assembly 130. The first fluid channel is defined as the e-liquid channel which connects e-liquid 104 to heat exchanger 122 and is an e-liquid channel found mostly adjacent to fluid valve 110 and fluid valve 112 between first e-liquid storage area 102 and second e-liquid storage area 124. First fluid valve 110 includes a biasing member 114, a valve stem 110, and a seal 118. Biasing member 114 may be a spring, magnet, compliant mechanism, liquid, or gas that provides force sufficient to hold valve stem seal 118 against valve seat 119. When tank assembly 128 is modularly separated from heat exchange assembly 130, e-liquid 104 is trapped inside tank assembly 128 by first fluid valve 110. Tank assembly 128 is a removable e-liquid pod which can be modularly connected and disconnected to heat exchanger assembly 130. Tank assembly 128 and heat exchanger assembly 130 are shown separated with first fluid valve 110 and second fluid valve 112 in a normally closed position sealing any e-liquid within tank assembly 128 and any e-liquid within heat exchange assembly 130 from leaking. Heat exchange assembly 130 includes second fluid valve 112, portions of first fluid channel 134, portions of second fluid channel 106, heat exchanger 122, electrical contacts 126, and inlet port 125. Heat exchanger 122 may include any type of heat vaporization device including resistive heating, inductive heating, direct flame heating, surface friction heating, direct surface heating, and laser light heating. Heat exchanger 122 may include: a resistive heating wire wrapped around a wick, a heating chamber, a ceramic heating chamber, an inner heat exchanger portion 122 and an outer heat exchanger portion 1022 (FIG. 10) extending through inlet port 125. In one embodiment, the outer heat exchanger portion 1022 (FIG. 10) may superheat inlet air using a torch, lighter, or flame. The superheated inlet air may exchange heat in heat exchanger 122 with an e-liquid supplied to heat exchanger 122 and cause evaporation of the e-liquid. In another embodiment, a flame may be drawn in through an outer heat exchanger portion 1022 and into inner heat exchanger portion 122 allowing for evaporation of e-liquid. Second fluid valve 112 includes a biasing member 116, a valve stem 112, and a seal 120. Biasing member 116 may be a spring, magnet, compliant mechanism, liquid, or gas that provides force sufficient to hold valve stem seal 120 against valve seat 121. When tank assembly 128 is modularly separated from heat exchange assembly 130, e-liquid is trapped inside heat exchange assembly 130 by second fluid valve 112. The first valve stem 110 and the second valve stem 112 are each biased in a normally closed position when the first e-liquid storage area 102 is modularly separated from the second e-liquid storage area 124. Portions of the first fluid channel are shown in FIG. 2 at 232, 234, and 224. The second fluid channel 106 connects outlet port 108 to inlet port 125 when the tank assembly and the heat exchange assembly are connected as shown in FIG. 2.

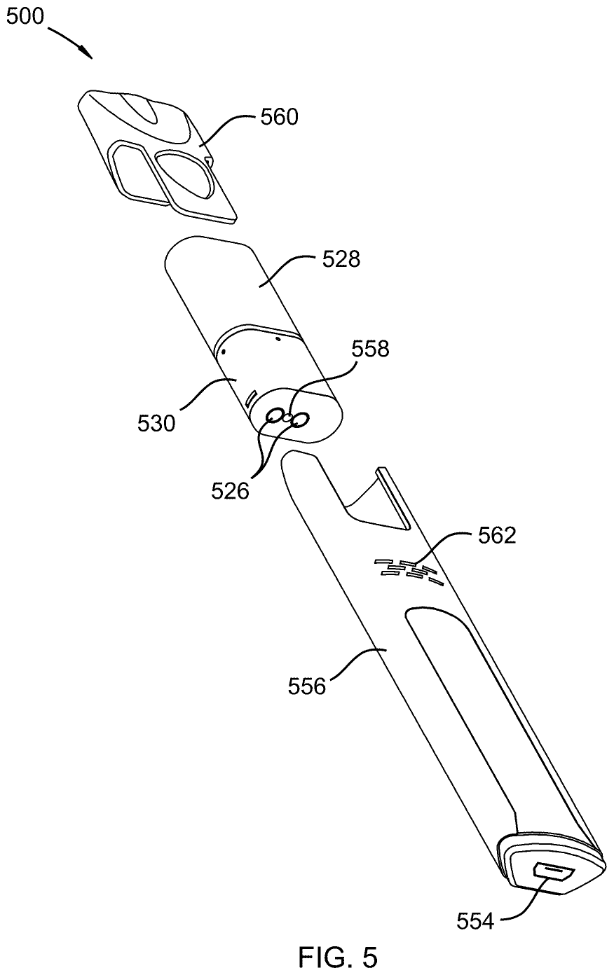

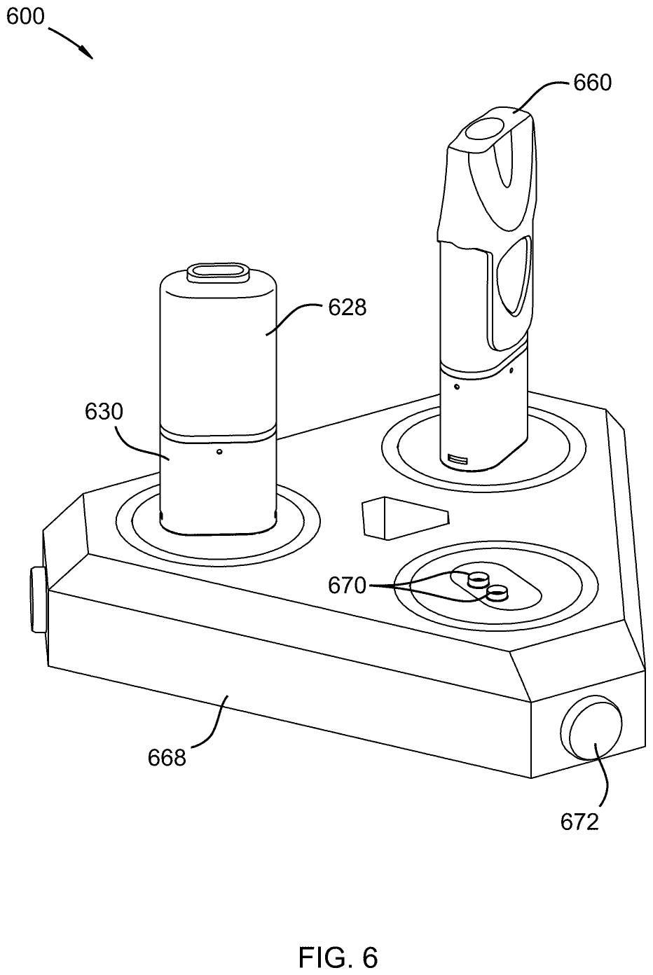

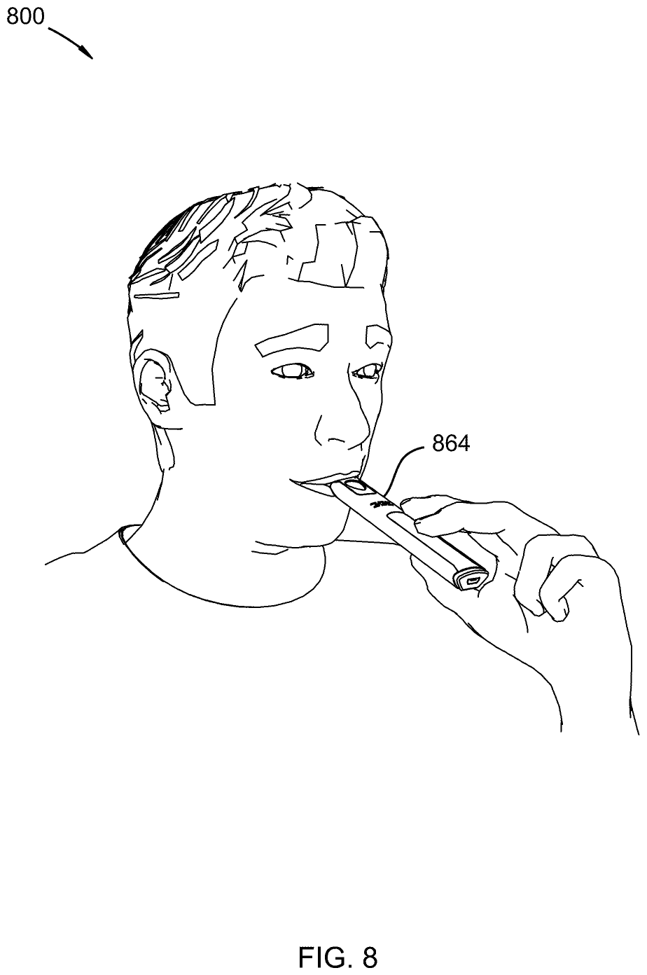

FIG. 2 shows a cross-sectional view of a connected vape device in accordance with an embodiment of the invention. Vape device 200 includes tank assembly 128 of FIG. 1 and heat exchange assembly 130 FIG. 1 modularly connected. Connected vape device 200 includes first e-liquid storage area 202, a second e-liquid storage area 224, an e-liquid 204, an outlet port 208, an inlet port 225, a first fluid valve 210, a second fluid valve 212, a first fluid channel 224/232/234, and a second fluid channel 206 extending from inlet port 225 through heat exchanger 222 to outlet port 208. First e-liquid storage area 202 includes e-liquid 204 and a first fluid channel which connects e-liquid 204 with a second e-liquid storage area 224 and heat exchanger 222. The first fluid channel is defined as the e-liquid channel which connects e-liquid 204 to heat exchanger 222 and is an e-liquid channel found mostly adjacent to first fluid valve 210 and second fluid valve 212 between first e-liquid storage area 202 and second e-liquid storage area 224. The first e-liquid storage area may to hold between 0.1 ml and 100 ml of e-liquid. First fluid valve 210 includes a biasing member 214, a valve stem 210, and a seal 218. Biasing member 214 may be a spring, magnet, compliant mechanism, liquid, or gas that provides force sufficient to hold valve stem seal 218 against valve seat 219. The connected vape device 100 includes second fluid valve 212, first fluid channel 224/232/234, second fluid channel 206, heat exchanger 222, electrical contacts 226, and inlet port 225. Second fluid valve 212 includes a biasing member 216, a valve stem 212, and a seal 220. Biasing member 216 may be a spring, magnet, compliant mechanism, liquid, or gas that provides force sufficient to hold valve stem seal 220 against valve seat 221. When tank assembly 228 is modularly connected, e-liquid 204 is able to flow through first fluid valve 210 and second fluid valve 212 to heat exchanger 222 by way of first fluid channel 232, 234, and 224. The first fluid valve 210 and the second fluid valve 212 operate synchronously as the valve stems mutually push against each other to open both valve at the same time when the tank assembly 228 is modularly connected to the heat exchange assembly 230. The second fluid channel 206 connects outlet port 208 to inlet port 225 when the tank assembly and the heat exchange assembly are connected as shown in FIG. 2. Heat exchanger 222 may include one or more of: a resistive heating wire wrapped around a wick, a heating chamber, a ceramic heating chamber, an inner heat exchanger portion 222 and/or an outer heat exchanger portion 1022 (FIG. 10) extending through inlet port 225. In one embodiment, the outer heat exchanger portion 1022 (FIG. 10) may superheat inlet air using a torch, lighter, or flame. The superheated inlet air may exchange heat in heat exchanger 222 with an e-liquid supplied to heat exchanger 222 and cause evaporation of the e-liquid. In another embodiment, a flame may be drawn in through an outer heat exchanger portion 1022 and into inner heat exchanger portion 222 allowing for evaporation of the e-liquid. In another embodiment, a resistive heating wire is wrapped around a wick and is provided enough current to evaporate e-liquid in the wick. Current may be provided by a local battery source in a vape device attachment as shown in FIGS. 5 and 8. In another embodiment, vape device 200 may be connected to an external energy source via contacts 226 and provided enough current to evaporate e-liquid in or near heat exchanger 222 allowing for one or two evaporated e-liquid doses before needing to be reheated as shown in FIGS. 6, 7, and 9.

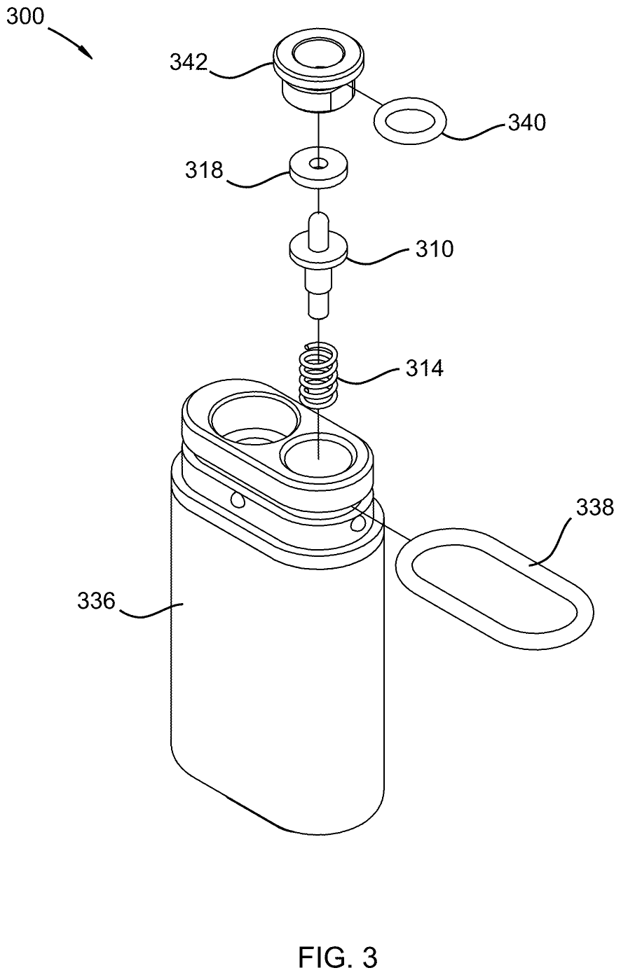

FIG. 3 shows an exploded view of tank assembly 300 in accordance with an embodiment of the invention. Tank assembly 300 includes tank assembly housing 336. The tank assembly housing provides an internal first e-liquid storage area, a first fluid channel including components of the first fluid valve, a second fluid channel, and a tank assembly seal 338. First fluid valve includes spring 314, valve stem 310, seal 318, valve nut 342, and o-ring 340. Tank assembly 300 may be configured to hold between 0.1 ml and 100 ml of e-liquid.

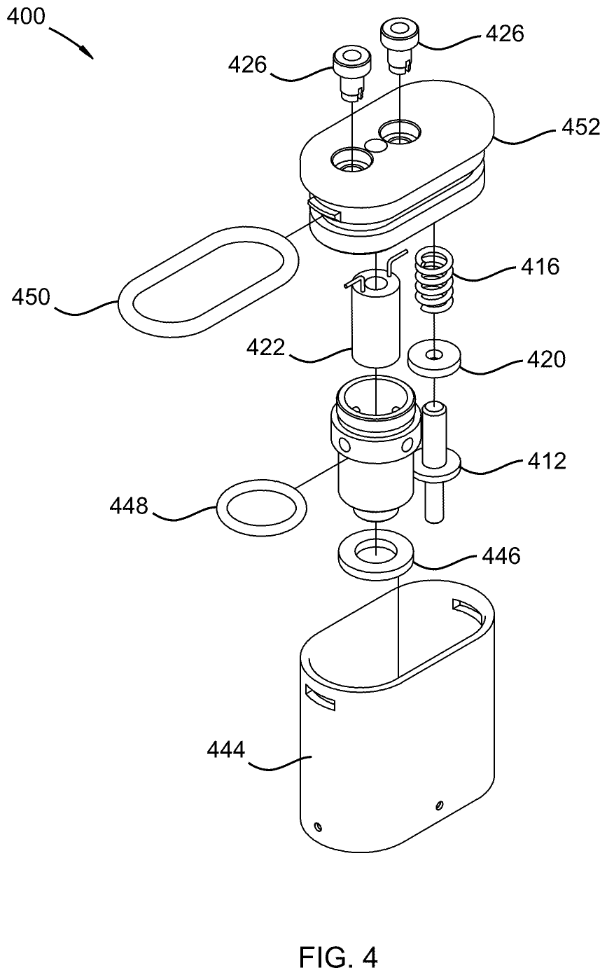

FIG. 4 shows an exploded view of a heat exchange assembly in accordance with an embodiment of the invention. Heat exchange assembly 400 includes heater/heat exchanger 422, electrical contacts 426, second fluid valve stem 412, seal 420, spring 416, inlet port seal 446, heat exchanger seal 448, heat exchange assembly seal 450, heat exchange assembly body 444, and heat exchange assembly inlet cap 452. Heat exchange assembly 400 may be arranged with different heat exchangers and components. Second valve assembly 412-420 may include thermostatic properties such as an expanding gas thermostatic valve which opens as the temperature of the heat exchanger rises enabling a temperature control function or dose control function of the e-liquid. Heat exchanger 422 may include an externally extending portion 1022 as shown in FIG. 10. The externally extending portion 1022 may comprise a direct flame heat exchanger portion which superheats inlet air. The direct flame portion 1022 may comprise a direct flame heated thermal electric module which supplies current to wires 426 when heated by a direct flame 1072.

FIG. 5 shows an exploded perspective view of a vape device in accordance with an embodiment of the invention. Vape device 500 includes mouth piece 560, tank assembly 528, heat exchange assembly 530, electrical contacts 526, inlet port 558, battery housing 556, charging port 554, and intake port 562. Mouth piece 560 may be magnetic and easily slide on and off for easy access to tank assembly 528 and for sharing of vape device 500 with others. Heat exchange assembly 530 slides into battery housing 556 and contacts 526 engage mating contacts within housing 556. Housing 556 includes batteries with a charging circuit and charging port 554. A button may be located on a bottom surface of housing 556 allowing a user of vape device 500 to send current to contacts 526 to start the vaping process. A user of the vape device may provide suction at mouth piece 560 to automatically start the vaping process instead of using an external button. A vape user may desire to exchange an empty e-liquid assembly 528 with a full e-liquid assembly. The user may separate vape device 500 and remove empty e-liquid assembly 528 and replace it with a full e-liquid assembly and insert the connected heat exchange assembly and full e-liquid assembly into the 556 and replace the mouth piece 560.

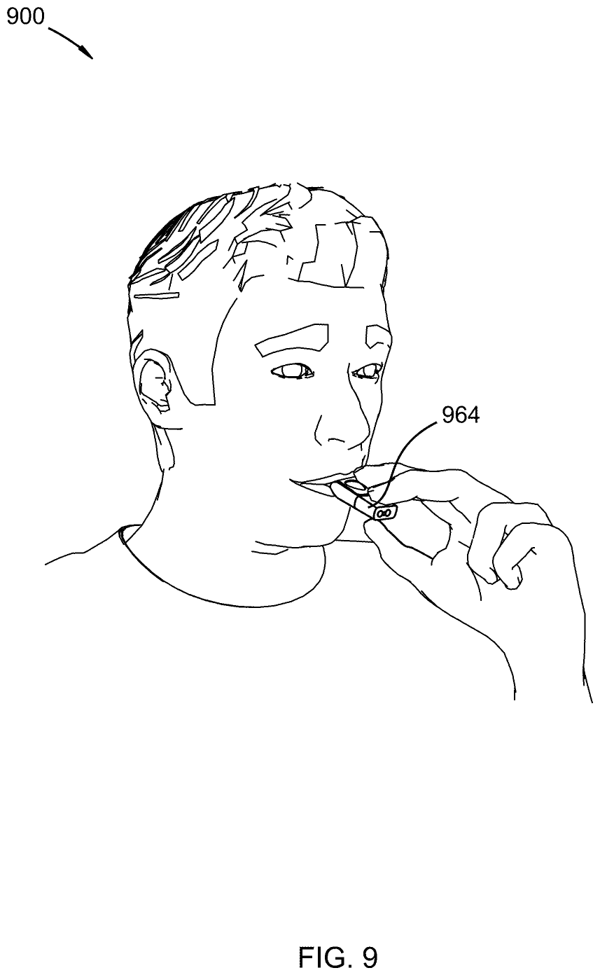

FIG. 6 shows a perspective view of an electric lighter and vape devices in accordance with an embodiment of the invention. Electric lighter station 600 allows a user of vape device 660 to heat up or light up a heat exchanger of heat exchanger assembly 630 by pressing button 672. When button 672 is pressed for 5 to 10 seconds, a heat exchanger within heat exchange assembly 630 is heated to a useable temperature for vaping. The user then is able to take one or two vape hits (shown in FIG. 9. Electric lighter 600 may be battery powered or corded. Batteries and/or other charging or current limiting circuitry may be located within base 668. Electric lighter 600 may be a hand held electric lighter allowing a vape user to have the vape device in their mouth when using the electric lighter to heat up or light up the heat exchanger of the vape device.

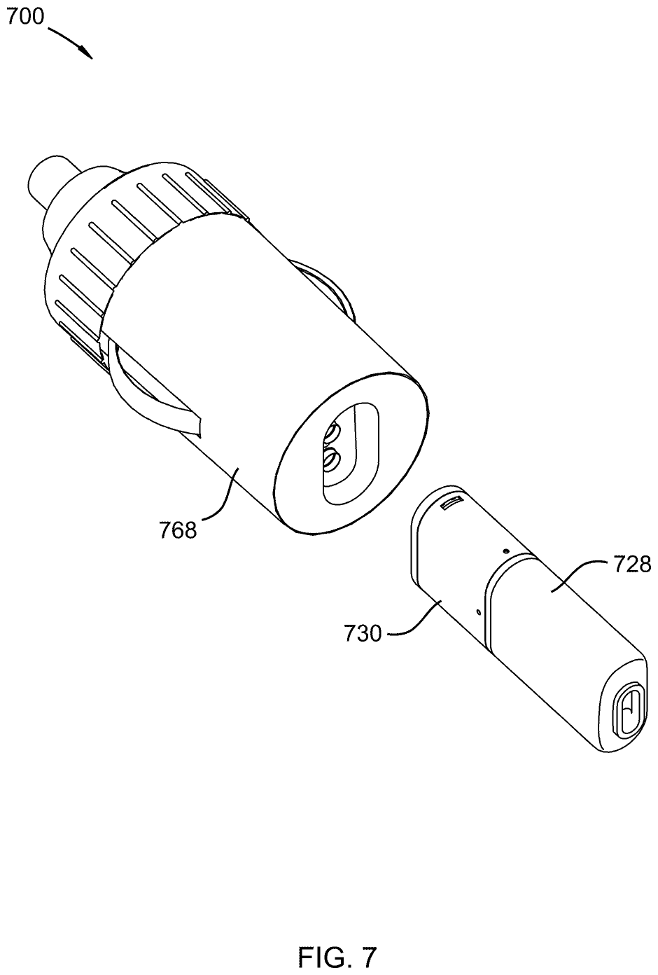

FIG. 7 shows a perspective view of an electric lighter and vape device in accordance with an embodiment of the invention. Electric lighter 700 allows a user of vape device 730/728 to heat up or light up a heat exchanger of heat exchanger assembly 730 by touching contacts of the vape device to contacts of the lighter. When contacts are engaged for 5 to 10 seconds, a heat exchanger within heat exchange assembly 730 is heated to a useable temperature for vaping. The user then is able to take one or two vape hits (shown in FIG. 9. Electric lighter 700 may be battery powered or corded. Batteries and/or other charging or current limiting circuitry may be located within base 768. Electric lighter 700 may be a hand held electric car lighter allowing a vape user to have the vape device in their hand when using the electric lighter to heat up or light up the heat exchanger of the vape device.

FIG. 8 shows a perspective view 800 of a vape device 864 in use in accordance with an embodiment of the invention. A vape user is using an embodiment of vape device 864 of the present invention. Vape device 864 includes a tank assembly and a heat exchange assembly as shown in FIGS. 2 and 5.

FIG. 9 shows a perspective view of a vape device in use in accordance with an embodiment of the invention. A vape user is using an embodiment of vape device 964 of the present invention. Vape device 964 includes a tank assembly and a heat exchange assembly as shown in FIGS. 2, 6, and 7.

FIG. 10 shows a perspective view of a vape cigar in use in accordance with an embodiment of the invention. In one embodiment, the outer heat exchanger portion 1022 may superheat inlet air using a torch, lighter, or flame 1072. The superheated inlet air may exchange heat in heat exchange assembly 1030 with an e-liquid supplied by tank assembly 1028 and cause evaporation of the e-liquid. In another embodiment, a flame may be drawn in through an outer heat exchanger portion 1022 and into inner heat exchanger portion allowing for evaporation of the e-liquid. Heat exchange assembly 1030 may be arranged with different heat exchangers and components. A valve assembly of heat exchange assembly 1030 may include thermostatic properties such as an expanding gas thermostatic valve which opens as the temperature of the heat exchanger rises enabling a temperature control function or dose control function of the e-liquid. A heat exchanger may include an externally extending portion 1022 as shown in FIG. 10. The externally extending portion 1022 may comprise a direct flame heat exchanger portion which superheats inlet air. The direct flame portion 1022 may comprise a direct flame heated thermal electric module which supplies current to wires of heat exchange assembly 1030 when heated by a direct flame 1072.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A vape device comprising:
a first fluid channel, a second fluid channel, a first fluid valve, a second fluid valve, and a heat exchanger that exchanges heat between the first fluid channel and the second fluid channel; and
wherein the first fluid valve and the second fluid valve are in series and operate synchronously to supply an e-liquid, by way of the first fluid channel, to the heat exchanger.

2. The vape device of claim 1 further comprising: a first e-liquid storage area and a second e-liquid storage area.

3. The vape device of claim 2, wherein the first fluid channel fluidly connects the first e-liquid storage area to the second e-liquid storage area.

4. The vape device of claim 3, wherein the first fluid valve and the second fluid valve are located between the first e-liquid storage area and the second e-liquid storage area; and wherein the first e-liquid storage area has a liquid volume capacity between 0.1 ml and 100 ml and the second liquid storage area has a liquid volume capacity between 0.001 ml and 2 ml.

5. The vape device of claim 4, wherein the first fluid valve and the second fluid valve provide a sealed disconnection between the first e-liquid storage area and the second e-liquid storage area.

6. The vape device of claim 5, wherein the sealed disconnection synchronously seals the first e-liquid storage area and the second e-liquid storage area, preventing leakage, when the first e-liquid storage area is modularly separated from the second e-liquid storage area.

7. The vape device of claim 1, wherein the first fluid valve and the second fluid valve operate synchronously as a result of the first fluid valve mechanically interacting with the second fluid valve.

8. The vape device of claim 7, wherein the mechanically interacting comprises a first valve stem of the first fluid valve pushing against a second valve stem of the second fluid valve.

9. The vape device of claim 8, wherein the first valve stem and the second valve stem are each biased in a normally closed position when the first e-liquid storage area is modularly separated from the second e-liquid storage area.

10. The vape device of claim 1, wherein the e-liquid is vaporized by heat transfer of the heat exchanger and the vaporized e-liquid is supplied through the second fluid channel to a user of the vape device.

11. A method of providing an e-liquid to a heat exchanger of a vape device comprising:
attaching a first e-liquid storage area containing the e-liquid and a first fluid valve to the vape device, the vape device containing a second fluid valve attached to a second e-liquid storage area; and
wherein the first fluid valve and the second fluid valve synchronously and fluidly interact to provide the e-liquid to the heat exchanger of the vape device as a result of the attaching.

12. The method of claim 11, wherein the first fluid valve and the second fluid valve synchronously open as the first e-liquid storage area and the second e-liquid storage area are joined together.

13. The method of claim 12, wherein the first fluid valve and the second fluid valve synchronously close as the first e-liquid storage area and the second e-liquid storage area are separated.

14. The method of claim 13, wherein first fluid valve and the second fluid valve are located between the first e-liquid storage area and the second e-liquid storage area; and wherein the first e-liquid storage area has a liquid volume capacity between 0.1 ml and 100 ml and the second liquid storage area has a liquid volume capacity between 0.001 ml and 2 ml.

15. The method of claim 14, wherein the first e-liquid storage area supplies the e-liquid to the second e-liquid storage area by gravity.

16. The method of claim 14, wherein the first e-liquid storage area supplies the e-liquid to the second e-liquid storage area by vacuum pressure.

17. The method of claim 11, wherein the first fluid valve and the second fluid valve operate synchronously as a result of the first fluid valve mechanically interacting with the second fluid valve.

18. The method of claim 17, wherein the mechanically interacting comprises a first valve stem of the first fluid valve pushing against a second valve stem of the second fluid valve.

19. The method of claim 18, wherein the first valve stem and the second valve stem are each biased in a normally closed position when the first e-liquid storage area is modularly separated from the second e-liquid storage area.

20. The method of claim 11, wherein the e-liquid is vaporized by heat transfer of the heat exchanger.
